(19) United States
(12) Patent Application Publication
(10) Pub. No.: US 2024/0362133 A1
(43) Pub. Date: Oct. 31, 2024

(54) METHOD AND APPARATUS FOR MODELING AND CATEGORIZING PROGRAMMABLE DEVICES TO IDENTIFY REPACKAGED, REMANUFACTURED, COUNTERFEIT, INFERIOR, SUSPECT, OR MODIFIED DEVICES

(71) Applicant: Graf Research Corporation, Blacksburg, VA (US)

(72) Inventors: Whitney L. BATCHELOR, Christiansburg, VA (US); Scott J. HARPER, Blacksburg, VA (US); James W. KOINER, Vinton, VA (US); Cody L. CROFFORD, Blacksburg, VA (US)

(21) Appl. No.: 18/371,496

(22) Filed: Sep. 22, 2023

Related U.S. Application Data
(60) Provisional application No. 63/462,604, filed on Apr. 28, 2023.

(51) Int. Cl. G06F 11/22; G06F 9/445

(52) U.S. Cl. CPC G06F 11/2236; G06F 9/44505

(57) ABSTRACT

A programmable device includes a programming interface configured to receive sensor construction information; resources configured to be programmed with the sensor construction information to implement sensors on the programmable device; data processing circuitry configured to execute the sensor construction information causing the sensors to measure and generate sensor information including characteristics of the programmable device; and input/output circuitry configured to output the sensor information to a programmable device categorization system. A programmable device characterization processing system generates categorization models for categorizing programmable devices, and a programmable device categorization system categorizes a programmable device under test (DUT).

This application claims priority from U.S. provisional patent application Ser. No. 63/462,604, filed on Apr. 28, 2023, the contents of which are incorporated herein by reference.

Devices may be categorized by aspects including device type, lot number, performance, or simply good/bad. Device categorization is of interest for several reasons, one of which is detection of counterfeits. Dwindling supplies of older parts and increasing costs of newer devices motivate counterfeiters to introduce counterfeit devices into the supply chain. One of multiple problems with counterfeit devices is there is no guarantee that counterfeit devices will meet the same quality standards as original devices.

One approach to identification of counterfeits is to destructively examine and statistically test a large set of sample devices, but this sample testing approach is costly and does not provide a measure of the integrity of the actual devices that are assembled into systems due to the destructive nature of the tests. A less invasive hardware-based approach using a chip testing appliance might be considered, but this still requires the device to be removed from a system and current approaches of this type, at best, only determine that a device belongs to a particular device manufacturing run, or “lot”, prior to including the device in an end-product assembled system. None of these approaches is effective in assessing devices contained in assembled systems given that the device must be removed from the system for testing. Furthermore, if a particular test appliance is used for an initial testing of a device, that specific test appliance must be used to perform any subsequent verification of the device. In short, test appliances and/or destructive reverse engineering prohibits using these verification methods after system assembly or in the field.

These approaches for identifying counterfeit devices, and more generally determining an integrity of an electronic device, are limited, destructive, and costly. What is needed is a verification technology that can effectively and efficiently determine electronic device integrity across the device lifecycle—from manufacture through deployment and use.

### SUMMARY

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

In some example embodiments, a computer system automatically categorizes programmable devices based upon programmatically extracted device characteristics without the need for specialized equipment. Example programmable devices include field-programmable gate arrays (FPGAs), central processing units (CPUs), and some additional application specific integrated circuits (ASICs). Although the examples are typically silicon-based devices, they need not be silicon based.

In some example embodiments, a programmable device includes a programming interface used to provide sensor construction information to the device and one or more resources configured to be programmed with the sensor construction information to implement, e.g., embed, one or more sensors on the programmable device. Data processing circuitry is configured to execute the sensor construction information causing the sensors to measure and generate sensor information including characteristics of the programmable device. The sensor construction information may include one or more telemetry bitstreams. In some example embodiments, the sensor construction information may be stored in a non-transitory computer-readable storage medium.

In some example embodiments, a programmable device characterization processing system is provided to generate categorization models for categorizing programmable devices. The programmable device characterization processing system includes at least one computer including at least one hardware processor and storage to store instructions. When the instructions are executed by at least one hardware processor, the programmable device characterization processing system: loads one or more sets of sensor construction information (sometimes referred to in this application as “sensor programs”) into the programmable resources of a known programmable device; operates the sensor programs in the known programmable device to generate one or more device characterization datasets including characteristics about the known programmable device; determines for the known programmable device one or more device category identifiers; assigns one or more device categories to the one or more known device characterization datasets (sometimes referred to in this application as “measured sensor data”) based on the device category identifier; processes the one or more known device characterization datasets by one or more modeling processes to develop one or more categorized device models for the known programmable device; and provides at least one of the one or more of the categorized device models to categorize a programmable device under test. In some example embodiments, the instructions for implementing the programmable device characterization processing system may be stored in a non-transitory computer-readable storage medium.

In some example embodiments, a programmable device categorization system is provided for categorizing a programmable device under test (DUT) that includes programmable resources. The programmable device categorization system includes at least one computer including at least one hardware processor and storage to store instructions. When the instructions are executed by the at least one hardware processor, the programmable device categorization system: loads a sensor program into the programmable resources of the DUT; operates the sensor program in the DUT to generate sensor information including characteristics about the DUT; receives and stores in the storage the sensor information from the DUT; processes the sensor information from the DUT using a categorization model to generate categorization information for the DUT; and outputs the categorization information. In some example embodiments, the instructions for implementing the programmable device categorization system may be stored in a non-transitory computer-readable storage medium.

In some example embodiments, the programmable device characterization processing system and the programmable device categorization system are combined in one system. In some example embodiments, the instructions for such a combined system may be stored in a non-transitory computer-readable storage medium.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is an example of a programmable device according to certain example embodiments;

FIG. 2 is a flowchart showing example procedures for producing telemetry sensors 214 that can be programmed onto a programmable device according to certain example embodiments;

FIG. 3 is a flowchart that illustrates example procedures for measuring and generating device characterization information based on the telemetry sensor bitstream generated in FIG. 2 according to certain example embodiments;

FIG. 4 is a diagram of an example type of telemetry sensor for a programmable device corresponding to a ring oscillator sensor according to certain example embodiments;

FIG. 5 shows a floorplan of constrained ring oscillator telemetry sensor placement in an example programmable device according to certain example embodiments;

FIG. 6 is an example of long ring oscillator (LRO) placement on the FPGA of FIG. 5 according to certain example embodiments;

FIG. 7 shows an example embodiment of a memory block telemetry sensor according to certain example embodiments;

FIG. 8 shows an example embodiment of a phase locked loop (PLL) telemetry sensor according to certain example embodiments;

FIG. 9 shows an example embodiment of an embedded multiplier telemetry sensor according to certain example embodiments;

FIG. 10 shows an example embodiment of a path delay time measurement telemetry sensor according to certain example embodiments;

FIG. 11 illustrates an example embodiment of a telemetry measurement sensor that uses a spread spectrum clock source as the launch clock according to certain example embodiments;

FIG. 12 shown an example embodiment of an optional test platform to support data collection of individual programmable devices according to certain example embodiments;

FIG. 13 shows an example programmable device evaluation system including an example programmable device characterization processing system and an example a programmable device categorization system that may be implemented together or separately according to certain example embodiments;

FIG. 14 shows one example method for collecting telemetry sensor measurement data for a programmable device in which the telemetry sensor bitstreams are programmed onto the programmable device according to certain example embodiments;

FIG. 15 illustrates an example system for data cleaning and wrangling where raw sensor data is manipulated into a format that facilitates analysis and model training according to certain example embodiments;

FIG. 16 shows an example flowchart for developing and training a device categorization model according to certain example embodiments;

FIG. 17 shows an example embodiment of a characterization system user interface (UI) main menu for the programmable device characterization system according to certain example embodiments;

FIG. 18 shows an example embodiment of a programmable device characterization system data analysis menu according to certain example embodiments;

FIG. 19 shows an example embodiment of a model training main menu according to certain example embodiments;

FIG. 20 shows an example user interface display menu of the categorization system according to certain example embodiments;

FIG. 21 shows an example user interface display menu where the provided details regarding the classification are provided and the verification process can be initiated according to certain example embodiments;

FIGS. 22-25 show example displays of potential part classification results including a valid part classification dialog example in FIG. 22; a suspect part classification dialog example in FIG. 23; an invalid part classification dialog example in FIG. 24; and an unknown part classification dialog example in FIG. 25 according to certain example embodiments;

FIG. 26 illustrates example categorization of programmable devices using a computing device in a cloud-based environment according to certain example embodiments;

FIG. 27 illustrates another example categorization of programmable devices in a cloud-based environment according to certain example embodiments; and

FIG. 28 shows an example computing system that may be used in some embodiments to implement features described herein.

### DETAILED DESCRIPTION

To address various problems with device categorization approaches and to reliably, accurately, and efficiently identify repackaged, remanufactured, counterfeit, inferior, suspect and/or modified programmable devices, example embodiments identify and categorize a programable device using a set of internal sensors constructed and implemented in the device, after the device has been manufactured, to categorize a device based on physical properties measured via programmed sensor. An example of this categorization is to determine an integrity of an electronic device including detecting a repackaged, remanufactured, counterfeit, inferior, suspect, and/or modified programmable device. The detection may be performed at different stages of a supply chain including on loose programmable devices or other device parts at initial manufacture all the way through programmable devices which are built into fielded systems. Although the integrity categorization example is used as the primary example throughout this application for purposes of providing a detailed example, other device categorization applications are included, e.g., categorizing devices to sort them, etc.

Example embodiments construct, e.g., embed, sensors on the fabricated programmable device using telemetry sensor bitstreams. A telemetry sensor bitstream is a sequence of binary bits representative of configuration data and/or a particular logic design of physical resources in a programmable device, e.g., an FPGA. In an FPGA, bitstream data may represent physical resources within a semiconductor chip configuration matrix where portions of the matrix represent configurable resources within the FPGA.

Once a telemetry sensor bitstream is constructed on the programmable device, the sensor then performs operations within the device that gather information relevant to the device's operational characteristics referred to as “device characterization information.” The device characterization information from the sensors is used to generate “device categorization information” for that device which can then be used to categorize a device under test to detect a repackaged, remanufactured, counterfeit, and/or modified programable device. Because the sensors may be programmed into the device after it has been manufactured, the development of models for the device and the use of such developed device models to later categorize devices under test avoids the problems and drawback described above with other approaches to determine the integrity of an electronic device by providing verification technology that effectively and efficiently determines device integrity across the device lifecycle—from manufacture through deployment and use.

Advantageously, the technology described in this application is broadly applicable throughout a supply chain involving the device, and no special external test equipment is required for testing and categorization. Instead, a sensor dataset from telemetry sensors implemented within the programmable logic of the device provides device characterization information for the programmable device that can be obtained without destructive evaluation of the device. Example embodiments evaluate data that can be measured from silicon level modifications in programmable devices.

Example embodiments may use modeling, machine learning, and/or statistical analysis to process the device characterization information obtained from the sensors programmed into the programmable device to determine and indicate whether the programmable device is genuine or counterfeit (the term “counterfeit” is sometime used as a shorthand term to refer an electronic device having a questionable integrity including a repackaged, remanufactured, counterfeit, inferior, suspect, and/or modified programmable device) and whether and how the programmable device may have been modified since manufacture. Programmable device modeling, machine learning, and/or statistical analysis may be used to produce a categorization model for a set of known devices. This categorization model may subsequently be used to process device characterization information returned from similar programmable devices to indicate their integrity such as whether they are genuine or counterfeit, the quality of each programmable device, the manufacturing lot each device belongs to, and/or provide other classifications related to each programmable device.

In this application, for purposes of explanation and non-limitation, specific details are set forth, such as particular nodes, functional entities, techniques, protocols, etc. to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Unless the context indicates otherwise, the terms circuitry and circuit refer to structures in which one or more electronic components have sufficient electrical connections to operate together or in a related manner. In some instances, an item of circuitry can include more than one circuit. An item of circuitry that includes one or more processors may sometimes be separated into hardware and software components. In this context, software refers to stored data that controls operation of the processor or that is accessed by the processor while operating, and hardware refers to components that receive, store, transmit, and operate on the data. Circuitry can be described based on its operation or other characteristics. For example, circuitry that performs control operations may be referred to as control circuitry, and circuitry that performs processing operations may be referred to as processing circuitry.

In general, processors, circuitry, and other such items may be included in a system in which they are operated automatically or partially automatically. The term system refers to a combination of two or more parts or components that can perform an operation together. A system may be characterized by its operation.

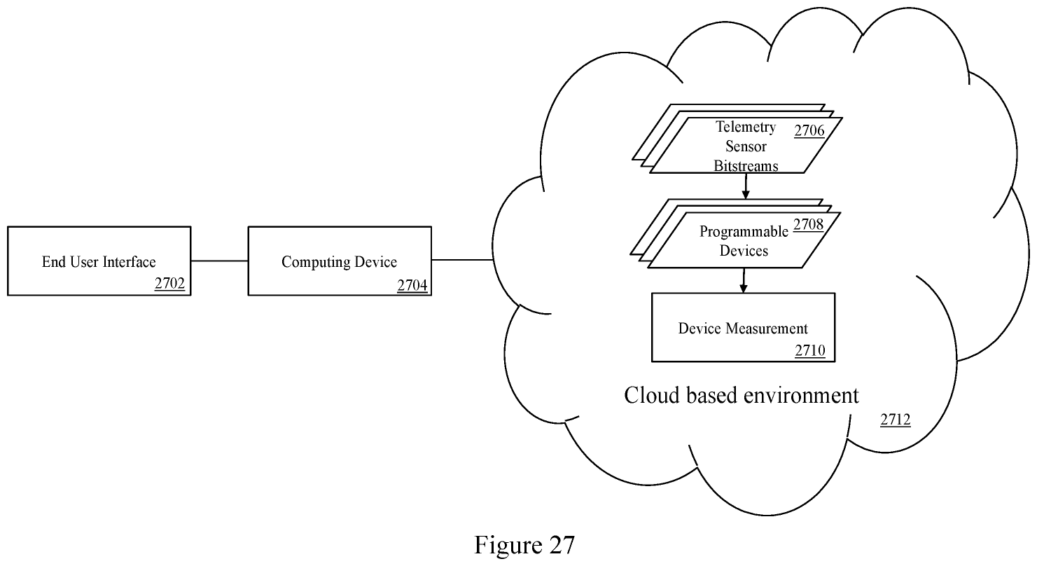

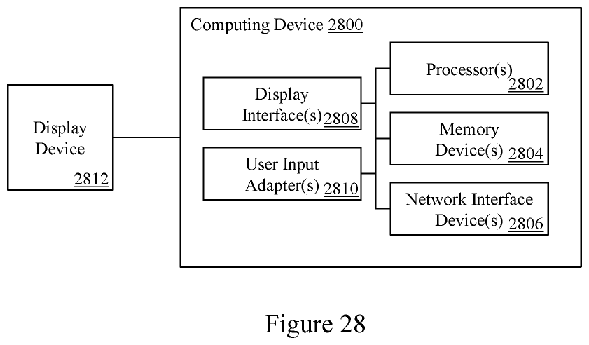

Computer-implemented function blocks, functions, and actions may be implemented using software modules. Function blocks, functions, and/or actions performed by software module(s) or processing node(s) are implemented by underlying hardware (such as at least one hardware processor and at least one memory device) according to program instructions specified by the software module(s). FIG. 28 and its description later in the application provide details of an example computer system with at least one hardware processor 2802 and at least one memory device 2804. In addition, the described function blocks, functions, and actions may be implemented using various configurations of hardware (such as ASICs, PLAs, discrete logic circuits, etc.) alone or in combination with programmed computer(s). References to one of the function blocks, functions, and/or actions performing some action, operation, function, or the like, refers to a computer system like the example computer system in FIG. 28 executing program instructions corresponding to the module to perform that action, operation, or function. Although the computer system may be implemented using a single computing device like that in FIG. 28, the computer system may also be implemented in a cloud-based computer environment like that in FIG. 27 and may be implemented across one or more physical computer nodes like the computing device as shown in FIG. 28. In certain examples, different aspects of the computer system 2800 may be implemented on virtual machines implemented on corresponding physical computer hardware. Programs, instructions, and data for execution may be stored in one or more non-transitory computer-readable storage media.

Detailed examples are provided below for categorization of an FPGA device. An FPGA is a type of reconfigurable semiconductor device that can be reprogrammed to provide new or different gate connection logic configurations. These detailed examples may be applied to any programmable device as either configured logic or programmed software.

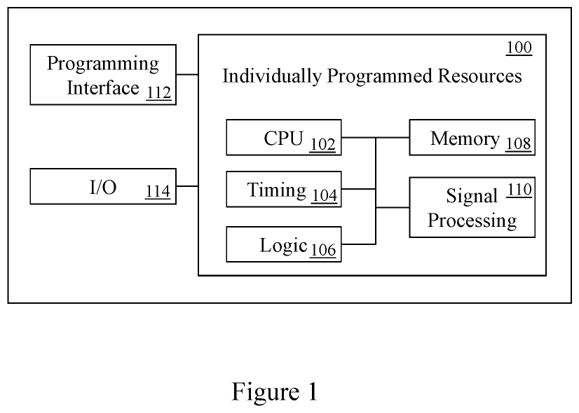

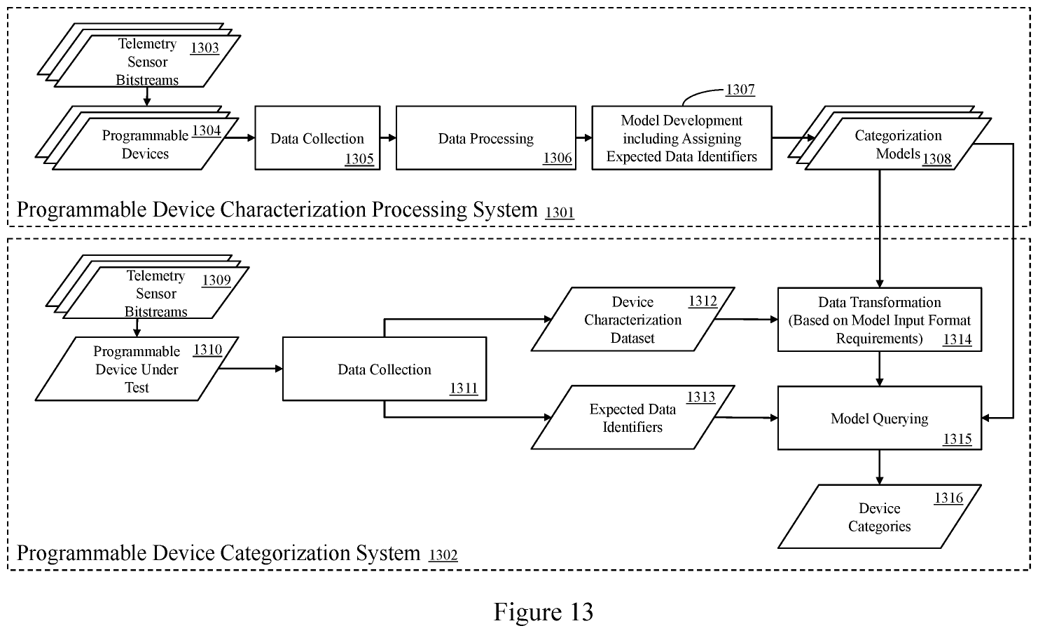

An example of a programmable device is illustrated in FIG. 1 and includes individually programmable resources including a central processing unit (CPU) 102, timing 104, logic 106, memory 108, and individually programmed resources 110. The programmable device includes a programming interface 112 to receive programming bitstreams from a programming system or other programming source (an example is described below in conjunction with FIG. 13), and an input/output (I/O) 114 for receiving and outputting information.

As described above, example embodiments construct, e.g., embed, program, etc., sensors on a fabricated programmable device like the one in FIG. 1 using telemetry sensor bitstreams. A telemetry sensor bitstream is a sequence of binary bits that load or program configuration data and/or a particular logic design into the programmable device. In the example telemetry sensors described below, the example programmable device is an FPGA. Other example programmable devices may be used. Once a telemetry sensor bitstream is loaded onto the programmable device, the telemetry sensor is part of and performs operations within the device that gather information relevant to the device's operational characteristics, which as mentioned above, is referred to as “device characterization information.” Each telemetry bitstream typically includes multiple telemetry sensors that each characterize a specific programmable device element, functionality, or feature of interest as a telemetry dataset. There is no limit to the number of telemetry datasets or data types that may be used to characterize the programmable device.

In example device sensor embodiments, five telemetry bitstreams program five different telemetry sensors including: a ring oscillator (RO) sensor, a long ring oscillator (LRO) sensor, a memory block (BRAM) sensor, a phase-locked loop (PLL) sensor, an embedded multiplier (EM) sensor, and a precision path timing (TIM) sensor. Each telemetry sensor is described in detail below in turn. A programmable device is programmed with each telemetry bitstream, and the characteristic data produced by the telemetry sensors, e.g., oscillation counts for a set of ring oscillators, is collected by reading the sensor results from the programmable device under test and storing them for later use.

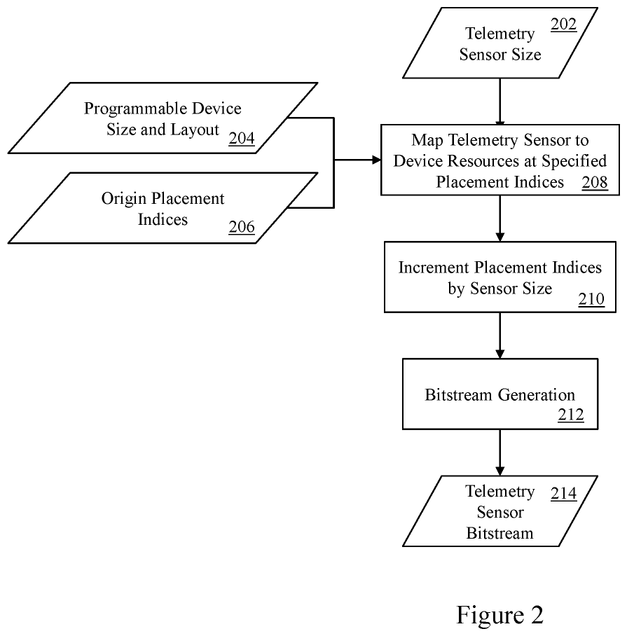

FIG. 2 is a flowchart showing example procedures for producing telemetry sensors 214 that can be programmed onto a programmable device. A developer may use a telemetry sensor size 202 determined by the number of programmable resources required or used to implement the telemetry sensor. The developer may also use a programmable device size and layout design 204 and origin placement indices 206 to map (locate) a telemetry sensor to the programmable resources of the device at specified placement indices 208, e.g., location coordinates, on the programmable device. Origin placement indices are the placement indices to which the first telemetry sensor is mapped. After mapping a telemetry sensor, the placement indices are incremented by sensor size 210 to specify the next resources in the programmable device to which a sensor can be mapped. The placement procedure repeats until desired telemetry sensors have been mapped to the available programmable resources in the programmable device. The telemetry sensors and the programmable device mapping are then processed by a bitstream generation process 212 which produces in a telemetry sensor bitstream 214.

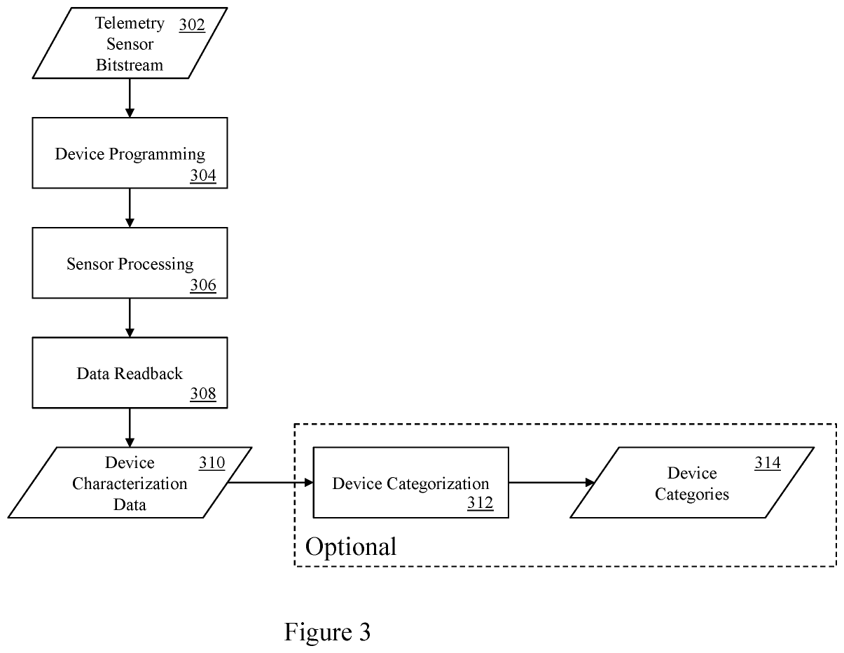

FIG. 3 is a flowchart that illustrates example procedures for measuring and generating device characterization information based on the telemetry sensor bitstream 302 generated in FIG. 2. The telemetry sensor bitstream 302 generated in FIG. 2 is provided to the programming interface 112 of the programmable device shown in FIG. 1. In a device programming step 304, the programming interface 112 directs the telemetry sensor bitstream to program one or more the device's programmable resources 100 shown in FIG. 1 to function as a particular type of telemetry sensor on the device. In a sensor processing step 306, the programmed resources 100 execute the sensor programming information causing the sensors to generate output sensor data. Output sensor data is read back 308 via the I/O 114 shown in FIG. 1; that data corresponds to device characterization information 310 that may be used, as described in detail later, to generate device categorization models that may be used to categorize programmable devices under test.

In another embodiment, the device characterization data 310 in FIG. 3 may also be used to generate device categories 314 by going through a device categorization process 1312 as described for FIG. 13 below.

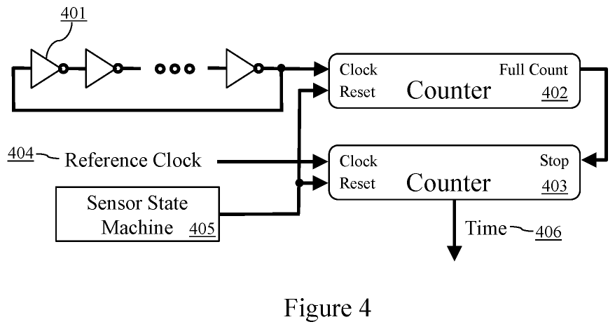

One example type of telemetry sensor for a programmable device is a ring oscillator sensor which can be programmed into the logic resources 106 of the programmable device. A ring oscillator includes an odd number of inverters 401 placed in a loop as shown in FIG. 4. The loop output oscillates between logic 1 and logic 0. A ring oscillator may be used to measure temporal and temperature aspects of a device, and in example embodiments, to characterize logic elements of a programmable device like an FPGA.

One specific example ring oscillator implementation is a ring oscillator sensor generation system that can be used with multiple device families and performs automated sensor generation. A device-specific sensor array is generated by providing the ring oscillator sensor generation system with two parameters: (1) the number of inverting stages that compose an individual ring oscillator and (2) the number of ring oscillator sensors placed throughout the FPGA. The telemetry sensor generation process in FIG. 2 places a specified number of programmed ring oscillator sensors throughout the programmable device with each programmed ring oscillator sensor being implemented with the specific number of inverter stages. The programmable device size (e.g., number of logic elements) and layout 204, the origin placement indices 206 of the ring oscillator sensors, and the ring oscillator sensor sizes 202 (e.g., 826 ring oscillators) are input into a scripted computer process which maps the telemetry ring oscillator sensor to the programmable resources 208 within the device at specified placement indices. The indices are incremented by sensor size 210 to adjust for programmable devices of different sizes. Then the telemetry ring oscillator bitstreams are generated 212, and the ring oscillator telemetry sensor bitstream 214 is output by the sensor generation process. Components of the ring oscillator sensor including the inverting stages 401, counters 402, 403, and a sensor state machine 405 are precisely and uniformly associated with (mapped to) specific programmable device resources 100 to achieve repeatability and stability within the measurements.

Ring oscillator sensors cannot be simultaneously mapped to all programmable resources in a programmable device as some resources are needed for collecting and outputting sensor measurements. Multiple telemetry sensor bitstreams are used with staggered placement of the ring oscillator telemetry sensors to maximize sensor coverage. Using multiple bitstreams, ring oscillator telemetry sensors can cover up to 98% of standard lookup table (LUT), multiplexer (MUX), and inverter logic resources with ring oscillator telemetry sensors.

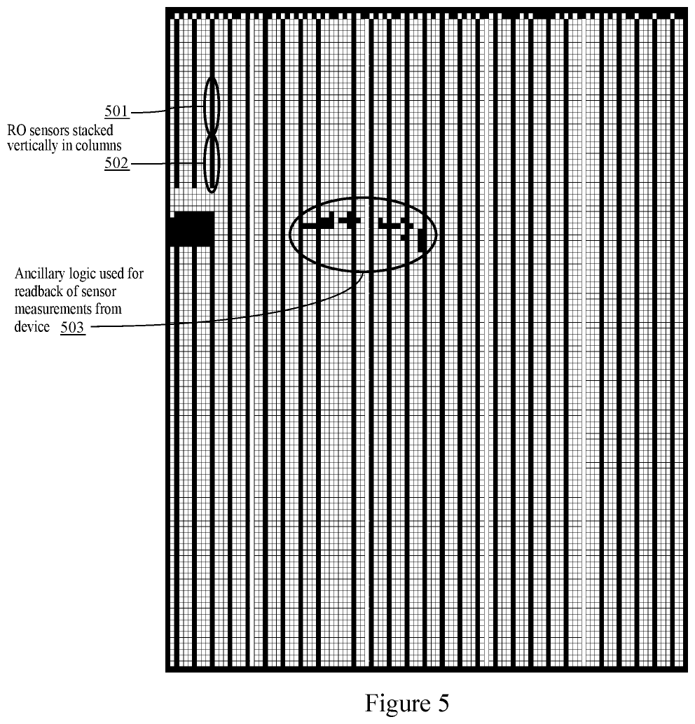

FIG. 5 shows a floorplan of constrained ring oscillator telemetry sensor placement in an example programmable device, an Intel Cyclone IV FPGA device. Each ring oscillator (RO) sensor 501, 502 in this example includes 15 inverter stages and six logic element resources collectively labeled 503 that are used for placement on this example FPGA. Placement of each ring oscillator (RO) sensor is constrained to vertically placed logic elements. When the maximum vertical placement in a column of logic elements is exceeded, a new column of RO sensors is created. Placing RO sensors vertically in columns facilitates avoiding columns of non-logic element resources such as memory blocks and embedded multipliers which are not used by this example implementation of the RO sensor.

One example embodiment of a ring oscillator sensor is a local RO sensor. Here, the ring oscillator sensor design includes rings confined to small areas, which results in ring oscillator delays that are dominated by the logic gates and not the routing of signals to and from the logic gates. Overall measurement of routing delays is another desirable feature of the FPGA to capture as it characterizes the routing resources that exist between logic gates of the FPGA. An additional ring oscillator telemetry sensor design may accomplish this by implementing ring oscillators with long routes. Each RO stage (inverter) in the long ring oscillator sensor is placed on the programmable device to provide longer wiring routes between the RO inverter stages.

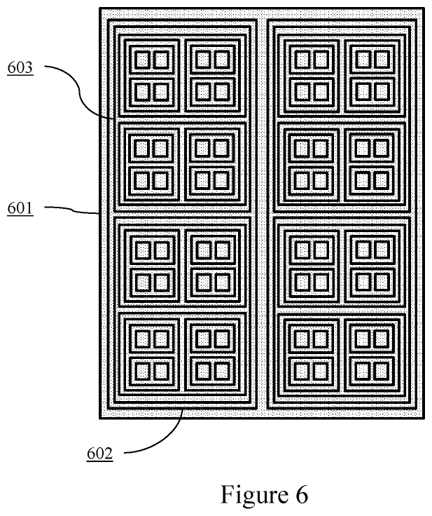

An example of long ring oscillator (LRO) placement on the FPGA is shown in FIG. 6. An example RO stage placement process is implemented as a set of operations that first creates a path containing an odd number of inverters using elements on the perimeter of the logic region that surrounds the FPGA 601, and then subdivides that region into two smaller halves. This set of operations is performed recursively to create a ring inside each of those regions 602, which are also subdivided 603. This recursion of operations repeats until a region is too small to support a new ring. In contrast to the local RO sensor example above, which uses between two and four bitstreams per FPGA size, the LRO sensor example uses one bitstream per FPGA size.

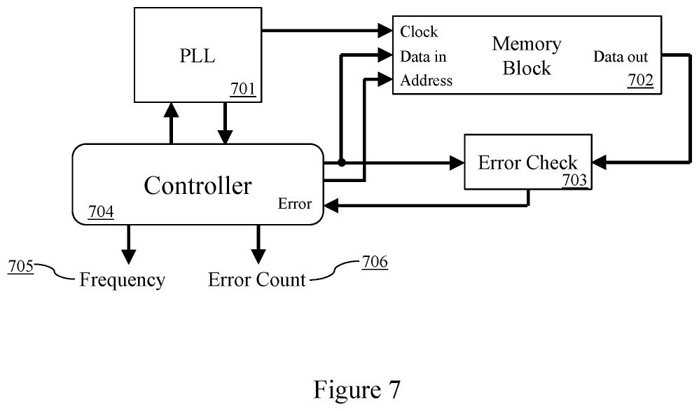

FIG. 7 shows an example embodiment of a memory block telemetry sensor, where the clock frequency 705 for a memory block 702 is incremented using a phase locked loop (PLL) 701 from a minimum value within or below specified FPGA device tolerances to a maximum value outside of the defined operational range (e.g., 125 MHz to 600 MHz is one example operational range for an Intel Cyclone IV FPGA). An error check 703 is performed for each location in a memory block 702 at each frequency by comparing readback of memory content from the output of the memory block 702 with an expected pattern output by a sensor controller 704. A mismatch indicates an error fed back to the controller 704, and the number of errors is counted by the sensor controller 704 and an error count 706 is output. This memory block telemetry sensor error count data is then output via the I/O of the FPGA. Due to the sometimes significant size of memory block sensors, full coverage of the memory blocks within a programmable device may require creation of multiple memory block telemetry sensor bitstreams that each contain memory block telemetry sensors for a set number of memory blocks. Once they are generated, the memory block telemetry sensor bitstreams are programmed onto a device (e.g., one by one), and the telemetry data they produce is stored and may be provided to a data handler in a device characterization processing system (e.g., 1301 shown in FIG. 13) or a categorization system (e.g., 1302 shown in FIG. 13).

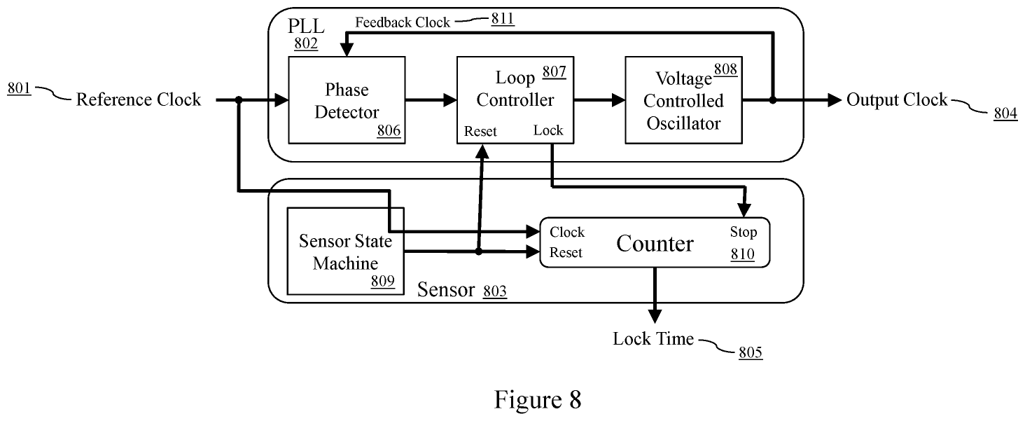

FIG. 8 shows an example embodiment of a phase locked loop (PLL) telemetry sensor. The operation of PLLs is analog in nature, making analysis difficult using only internal digital resources in programmable devices like FPGAs. One characteristic of PLLs that can be readily measured using digital logic resources within the FPGA, however, is the PLL lock time 805. PLLs take time to fully adjust (lock) the frequency and phase of their output clocks relative to their input clocks (i.e., reference clock 801) when they are first turned on. The time between releasing the PLL from reset and the PLL achieving lock is the PLL lock time 805.

FPGA PLL blocks typically have reset inputs and lock outputs which allow for a PLL telemetry sensor structure that measures the lock time. Referring to the example PLL sensor in FIG. 8, a PLL 802 includes a phase detector 806, loop controller 807, and voltage-controlled oscillator 808, and a PLL telemetry sensor 803 includes a sensor state machine 809 and a counter 810. The PLL telemetry sensor state machine 809 holds the PLL 802 in reset until a timing measurement is to be made. To make a timing measurement, the PLL telemetry sensor state machine 809 releases the PLL reset of the counter 810 and simultaneously starts the counter 810 based on the reference clock 801. The counter 810 is then halted by the lock signal coming from a loop controller 807 of the PLL 802. The value of the stopped counter 810, multiplied by the clock period, indicates the PLL lock time 810. The lock time 810 of each of the available PLLs may be measured multiple times to produce a statistically relevant result.

In constructing a telemetry bitstream for the PLL telemetry sensor, each PLL within an FPGA device is implemented with its own lock measurement circuitry. Overall operation of the PLL telemetry sensors may be externally controlled through a programming interface 112 of the FPGA (see FIG. 1), and the I/O 114 may be used to export the measured PLL telemetry sensor data.

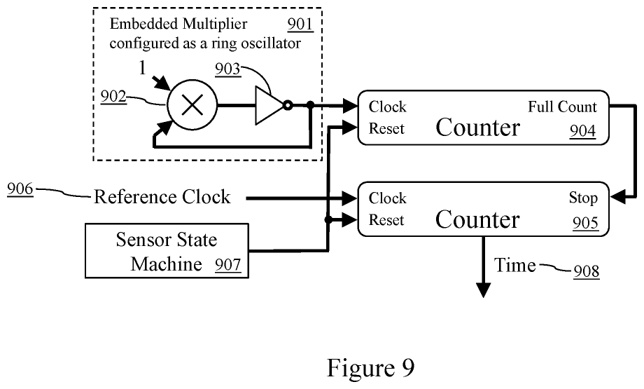

FIG. 9 shows an example embodiment of an embedded multiplier telemetry sensor 901 configured as a ring oscillator. Like the ring oscillator (RO) telemetry sensor, the embedded multiplier telemetry sensor characterizes embedded multiplier elements found within a programmable device like an FGPA device using a structure that results in free-running signal oscillation. A difference between the RO telemetry sensor and the embedded multiplier telemetry sensor is the construction of the oscillator. Oscillation with embedded multiplier resources is generated by creating an input vector with the most significant bit set to logic 1 and all other bits set to logic 0. One input to a multiplier 902 included in the embedded multiplier 901 is fixed to logic 1, and the other input to the multiplier 902 is configured with the most significant output bit from the output of an inverter 903 fed back to the other input. This allows the inversion operation to propagate through the multiplier 902 in a monotonic way. In producing a telemetry bitstream, the telemetry sensor placement is constrained throughout the FPGA device to maximize resource coverage.

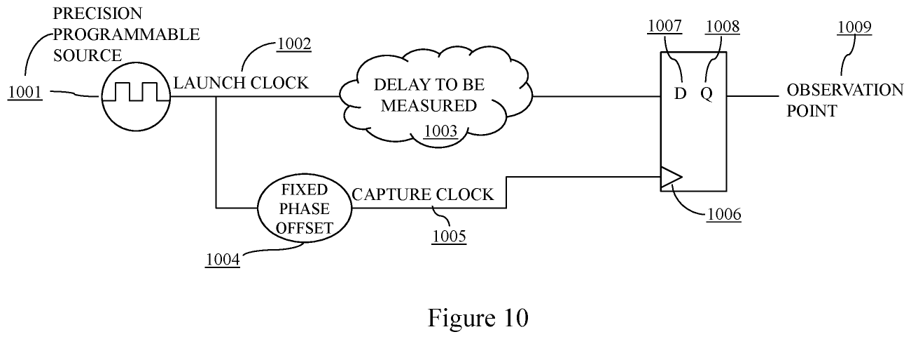

FIG. 10 shows an example embodiment of a path delay time measurement telemetry sensor. One way of making a time measurement of an element or path through a collection of elements within a programmable device is to use two clocks: a launch clock 1002 and a capture clock 1005 which are both generated from a precision programmable source 1001. The launch clock 1002 produces rising and falling transition edges presented to a conductor path to be measured 1003. Because the source 1001 for the launch clock 1002 is programmable, the launch clock 1002 is able to adjust its frequency in fine steps. The launch clock signal 1002 propagates through the delay path 1003 to be measured, where it is then presented to the D input 1007 of a flip-flop. A capture clock signal 1005 has a known (e.g., fixed) phase relationship 1004 to the launch clock signal 1002. The capture clock signal 1005 is presented to the rising-edge clock input 1006 of the capture D flip-flop. When the capture clock signal 1005 has a phase delay that is less than the path delay of the path being measured 1003, the D flip-flop will register as a ‘0’ at its Q output 1008 since the launched signal will not have arrived at the D input. Likewise, when the phase delay of the capture clock is greater than the path being measured, the D flip-flop will register a ‘1’ at its Q output 1008 since the launched signal will have arrived at the D input. When the phase delay of the capture clock is equal to that of the path to be measured, the output 1008 of the flip-flop (plus the D-to-clock set-up time of the flip-flop) will be a mixture of ‘1’s and ‘0’s due to the arrival of the launched signal 1002 occurring near the required setup and hold time for the D input 1007. The value of the phase offset 1004 at this point defines the delay of the path being measured. An example embodiment of a telemetry sensor design for this launch and capture is illustrated in FIG. 10.

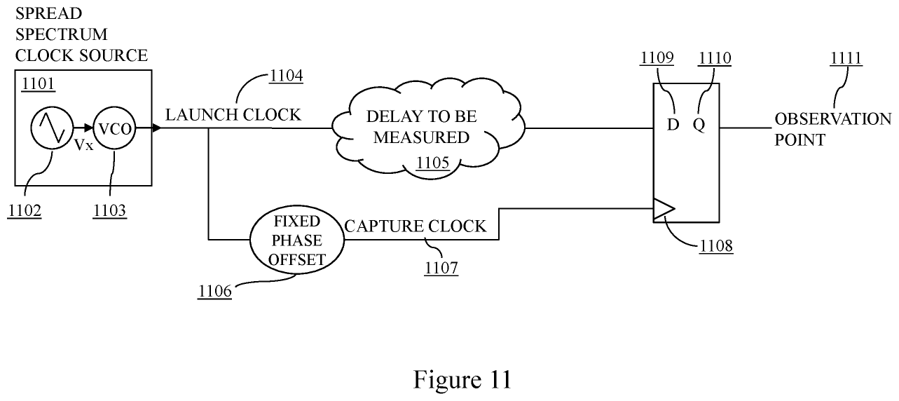

The center frequency of the launch clock source in FIG. 10 can be adjusted, but not necessarily in fine frequency steps. In another embodiment, a statistical method can be used to provide even finer resolution path delay measurements. Spread-spectrum clocking sweeps a clock frequency with an upper and lower bound; thus, broadening the spectral footprint that is traditionally applied for lowering the magnitude of individual spectral components. Spread-spectrum clocking can also be used to enhance a path timing sensor. FIG. 11 illustrates an example embodiment of a telemetry measurement sensor that uses a spread spectrum clock source 1101 as the launch clock 1104. The frequency sweep of the clock source is typically created with a volage-controlled oscillator (VCO) 1103 driven by a known driving function 1102, i.e., the properties of the VCO driving waveform are known, and in this example is a triangle wave.

With a spread spectrum driving function telemetry sensor shown in FIG. 11, the capture clock phase offset 1106 will sometimes be less than the delay to be measured 1105 and sometimes greater than the delay to be measured 1105 to produce a distribution of 1s and 0s at the observation point 1111. Given that the driving function 1102 of the VCO 1103 of the spread spectrum driving function telemetry sensor is known, the distribution of 1s and 0s at the observation point 1111 will provide information to precisely calculate the phase offset of the capture clock 1107 provided to the clock input 1108 of the D flip-flop 1109 that matches the delay to be measured minus the set-up time of the D flip-flop 1109. The precision of the measured pathway time duration is limited only by the statistical knowledge of the spread-spectrum source and the number of points observed on the output of the circuit. Leveraging this telemetry sensor structure, the delay of any path within an FPGA can be measured to high precision without the need for any external equipment.

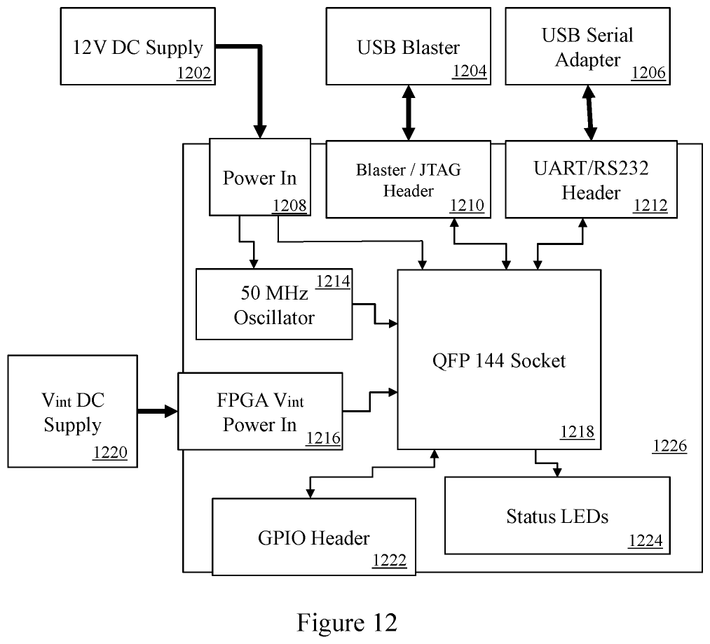

A test platform may optionally be used to support data collection of individual programmable devices. An example embodiment of a test platform shown in FIG. 12 includes input for the programming interface and input for powering the device under test. The example test platform block diagram in FIG. 12 contains a socket 1218 that supports quad-flat packaged (QFP) programmable devices and can be used with devices containing different amounts of programmable resources. The architecture of the test platform may be reused to support programmable devices with different packaging and physical size requirements.

The example test platform 1226 in FIG. 12 includes the following features:
Zero-insertion-force (ZIF) socket supporting 144-pin QFP packages for the FPGAs
Power handling including:
   A DC-DC converter with 3.3V output.
   A DC-DC converter with 2.5V output.
   Screw terminals 1208 for connecting a 12V supply 1202 to the 3.3V and 2.5V converters.
   Screw terminals for the FPGA internal Vint power 1216, which is supplied by an external source 1220.
A JTAG-based FPGA programming header 1210 for connecting to a USB Blaster programmer 1204.
A serial port header 1212 for connecting to a USB Serial Adapter 1206.
A GPIO header 1222 for access to additional FPGA I/O pins.
Status LEDs 1224 for visual indication of FPGA power and programming.
50 MHz oscillator 1214 for supplying a clock signal to the FPGA.

An example programmable device evaluation system is shown in FIG. 13. Old, repurposed, and/or used programmable devices often have unique data features that can be detected using sensor information obtained from telemetry sensors (such as the example telemetry sensors described above) that are constructed/implemented in a programmable device after its manufacture using telemetry bitstreams. Analysis of the telemetry sensor information from the programmable device allows, for example, identification of characteristics of counterfeit devices including previously used counterfeit devices that were repackaged as new devices and devices that were initially produced as counterfeits using stolen or cloned intellectual property (IP). This quantification can also reveal silicon-level modifications to the device including a shift of manufacturing to an alternate facility or the addition or removal of circuitry.

The programmable device evaluation system in FIG. 13 includes two subsystems: a programmable device characterization processing system 1301 and a programmable device categorization system 1302. These two subsystems may be implemented together or as separate processing systems.

The programmable device characterization processing system 1301 is a computer-implemented, software-based tool set for the ingestion, processing, transformation, and analysis of telemetry data required to train a categorization model to classify devices and identify the integrity of a device including whether a device repackaged, remanufactured, counterfeit, inferior, suspect and/or modified programmable device. Telemetry sensor bitstreams 1303 are input from one or more telemetry sensors that have been constructed/implemented on the physical resources of each of one or more known and authentic programmable devices 1304 (multiple devices are shown in the example in FIG. 13) to provide, e.g., embed, telemetry sensors on the known and authentic programmable device 1304. The telemetry sensors are operated and generate telemetry sensor data that corresponds to various characteristics of the known and authentic programmable device 1304. This telemetry sensor data is programmable device characterization information for the known and authentic programmable devices 1304.

Further data processing 1306, such as wrangling, transformation, and data cleaning (e.g., removing erroneous data) may occur to manipulate the data into usable formats, check for errors, and/or reformat for modeling, machine learning, or other purpose. If such data manipulation is used, then the manipulated data is the programmable device characterization information for the known and authentic programmable devices 1304.

The known and authentic programmable device characterization information is input into a programmable device model development and training module 1307 to develop and train a programmable device model to recognize that category of programmable device. The programmable device model performance is tuned by modifying the model and perhaps other parameters to obtain an optimally performing device model given the known and authentic programmable device characterization data. The trained device model is saved as a programmable device categorization model likely along with other similar programmable device categorization models 1308 used by the programmable device categorization system 1302 (described below) to test unknown and/or unverified devices referred to as “devices under test.”

To test a programmable device under test (DUT) 1310, the example programmable device categorization system 1302 programs the telemetry sensor(s) into the programmable resources of the DUT using telemetry sensor bitstreams 1309. DUT data is collected 1311 from the DUT in the same way as described above for known and authentic programmable devices 1304. A device characterization dataset 1312 is generated from the collected DUT data may be reformatted 1314 based on input format requirements of a device categorization model to be used. Expected data identifiers 1313 are also obtained corresponding to the previously collected programmable device data. Both the DUT characterization information 312 and the expected data identifiers 1313 are input into and processed by a categorization model 1315 provided from the categorization models 1308 in the programmable device characterization processing system 1301 resulting in device category outputs 1316.

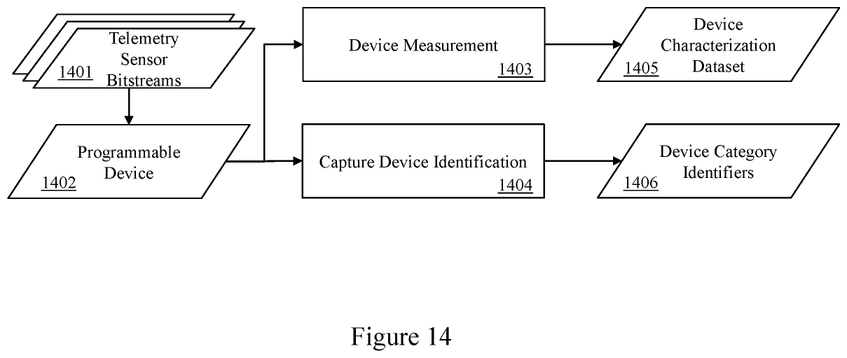

Additional details for some of the operations in FIG. 13 are now described. Data collection from programmable devices occurs in both the programmable device characterization processing system and the programmable device categorization system. FIG. 14 details one example method for collecting telemetry sensor measurement data for a programmable device in which the telemetry sensor bitstreams 1401 are programmed onto the programmable device 1402. Each telemetry sensor is programmed (loaded) in physical resources on the device using a telemetry sensor bitstream. The telemetry sensor is executed, e.g., by the example computing system in FIG. 28, and collects sensor measurement data 1403 for the device. Examples of collected telemetry sensor data using some of the telemetry sensor examples described earlier include ring oscillator counts per frequency, the frequency at which memory blocks fail, and/or the PLL lock time. The collected telemetry sensor data is stored in the programmable device characterization processing system 1301 and used to train device categorization models 1308. In the programmable device categorization system 1302, the collected DUT telemetry sensor data is stored as a device characterization dataset 1405 that contains one or more device category identifiers 1406 for the DUT. The device category identifiers 1406 are a set of features describing the programmable device of interest and are useful in categorizing a DUT device, e.g., identifying a counterfeit. An example device category identifier 1406 for a DUT is a device part number.

In example embodiments, the various data described above may be stored in a comma separated text file (a CSV file). A header denotes the column identifiers, and each row is a sequence of measurements collected from the device. An example sequence may look like “43,52,21,85,46 . . . ” Other file types and formats, including e.g., databases or in-memory storage, may be used.

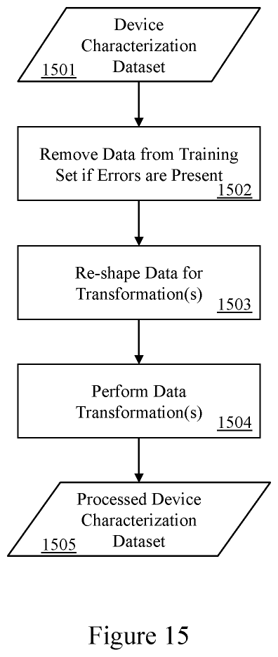

The data files produced from sensor measurement data 1403 may optionally undergo data cleaning and wrangling as shown in FIG. 15 where raw sensor data is manipulated into a format that facilitates analysis and model training. A device characterization dataset 1501 is evaluated for errors, and data samples with errors are removed 1502 from the device characterization dataset 1501 to be used for training. The remaining data is then reshaped for data transformation 1503 and manipulated via a selected data transformation 1504. Example data transformations are listed below in Table 1. The transformed data is a processed device characterization dataset 1505 and serves as input for model development and training in the programmable device characterization processing system 1301 or device categorization in the programmable device categorization system 1302. Example data transformations are described in Table 1.

TABLE 1
Example Transformations

| Transformation Name | Description |
|---|---|
| Best Correlation | Retrieves the n most correlated columns relative to the target |
| | identifier column. Target identifier is selected by the user from |
| | the columns in the sensor data file. |
| Data Quality Report | Produces a DQR describing different statistical features of the |
| (DQR) | collected data |
| Fast Fourier | Performs Fast Fourier Transform on the data and selects the |
| Transform, Imaginary | imaginary coefficients |
| Logarithmic (Base 2 | Performs a logarithmic function on the collected data |
| and 10) | |
| Natural Log | Performs a natural log function on the collected data |
| Principal Component | Performs PCA to find the minimum number of features that |
| Analysis (PCA) | cover 95% of the variance in the data |
| Power (Exponent of 2, | Performs a power function on the collected data |
| 3, and 4) | |
| Reciprocal | Takes the reciprocal of the collected data |
| Square Root | Performs a square root function on the collected data |
| Univariate Selection | Selects the n best columns associated with the target identifier |
| | column using a chi-squared test. Target identifier is selected |
| | by the user from the columns in the sensor file. |

The transformation(s) that can be applied to the data and which transformation(s) to apply are model dependent. Some transformations are better for statistical analysis, while others may be better for machine learning model training. For example, a logarithmic function may be used if sensor data displays exponential growth to gain a better understanding of the rate of change over the sensor parameters. A univariate selection transformation will reduce the dimensionality of the dataset, which may improve the performance of a machine learning model. Utilizing various data transformations often provides a different view into the telemetry sensor data allowing for more precise understanding and thus a more accurate and precise device categorization.

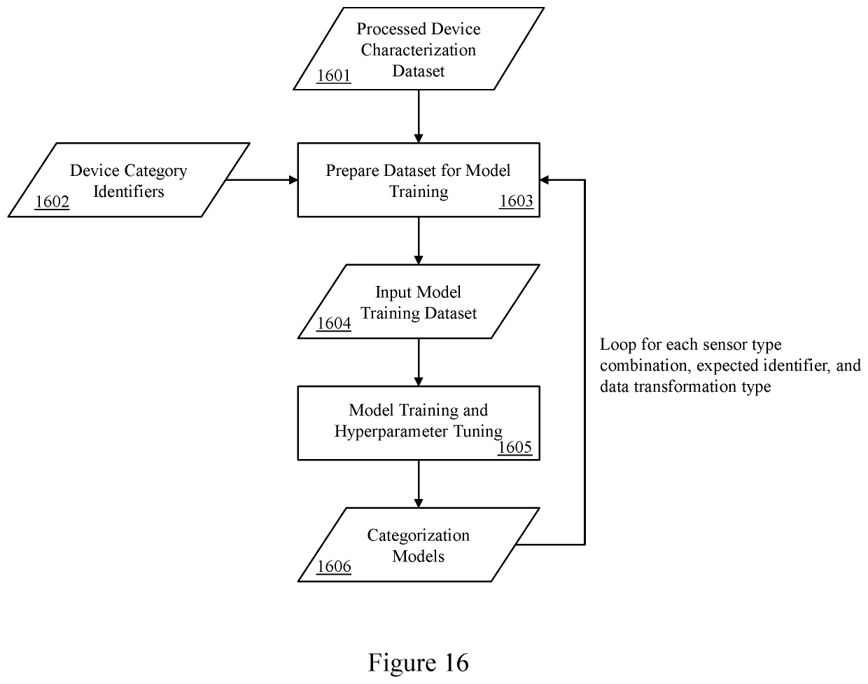

Once the collected bitstream data is shaped and transformed, it is ready for device categorization model development, an example of which is shown in the flowchart in FIG. 16. Any type of model may be used. One type of model includes machine learning (ML) models. Example ML models include a convolutional neural network (CNN), long-short term memory (LSTM), recurrent neural network (RNN), a transformer, a multi-layered perceptron, and a naïve Bayes classifier. Other ML models may be used. Each device categorization model is trained and may be combined by an ensemble process. Ensemble modeling is when two or more models each generate a categorization result; individual categorizations are aggregated by identifying the most common result across all models. The common result is then deemed the overall ensemble result.

A model includes model definitions, model training algorithms, and utility functions used for facilitating the implementation of the model training algorithms. In the example shown in the flowchart of FIG. 16, which uses a “supervised” modeling method that uses known identifiers to match the sensor data, the model inputs device category identifiers 1602 and the processed device characterization dataset 1601, i.e., the collected telemetry sensor data that has gone through data cleaning and wrangling, from the set of known and authentic programmable devices. In the process of building the model training dataset 1603, a user provides via a user interface menu (an example menu screen is described below) which data identifiers are to be attached to the dataset. Example data identifiers include a unique device number, a device lot number, or a binary label associated with the device. The data identifiers serve as a classification category of the model and may be used to identify an integrity of a device including predicting whether a device is suspect, e.g., is a repackaged, remanufactured, counterfeit, inferior, suspect and/or modified programmable device. If a DUT is categorized in the device categorization system with one identifier with high certainty, but a different identifier was expected based upon known device information—then the DUT can be classified for example as a type of repackaged, remanufactured, counterfeit, inferior, suspect and/or modified programmable device.

The processed device characterization dataset and device category identifiers are transformed into a list of data pairs representing the features of the telemetry sensor and its corresponding identifier, resulting in an identified input model training dataset 1604. The identified models are input into the training process, and hyperparameter tuning 1605 (e.g., adjustment of model weights, epochs, batch size, etc. described further below) occurs to determine optimal performing categorization models 1606. This process is repeated for each sensor type combination, expected identifier, and data transformation type.

The model training in step 1605 begins by obtaining the unique subset of data identifiers to determine the number of device categories to be identified by each model. When only two classes are available, binary loss functions are used, and the size of the network output will reflect the binary classification. For more than two data identifiers, a multi-classification technique may be used in the construction of the model. The model may be built using the resulting loss function, optimization function, and the label classification dependent dimension of the output layer of the model.

Hyperparameters for the model use either pre-defined defaults or user specified values and may include a learning rate, a, an epoch, which is a number of passes over the entire training dataset during the training process, and batch size, which is a number of data examples for the model to be trained on per iteration.

The model training process trains on the dataset for a user specified number of epochs. Each epoch is broken up into steps or iterations. After each iteration, a loss is calculated, and an optimization function is applied to the model. A model error and accuracy can be calculated after each iteration or at the end of each epoch during training. Loss, error, and accuracy metrics may be saved as training history data points, i.e., metrics, to be used for evaluating the model. These metrics can be used as convergence (stopping) conditions as the model development matures. Example models are listed below in Table 2 (again other models may be used).

TABLE 2
Metrics are reported based on a validation dataset

| | | | | Data | |
|---|---|---|---|---|---|
| | | | Sensor | Transfor- | Model |
| Target Label | Accuracy | Loss | Type | mation | Type |
| Trace Code | 100 | 1.02e−07 | PLL | PCA | MLP |
| Lot Number | 98.73418 | 0.196885 | PLL | PCA | MLP |
| Serial Number | 98.73418 | 0.063644 | PLL | PCA | MLP |
| Property ID | 98.73418 | 0.022435 | BRAM | Best | MLP |
| | | | | Correlation | |
| Date Code | 91.13924 | 0.013527 | PLL | PCA | MLP |

The programmable device categorization system 1302 includes an interactive user interface on a display (example menus are described below) that a user uses to determine an integrity of a device including if a DUT is a repackaged, remanufactured, counterfeit, inferior, suspect and/or modified programmable device. The expected data identifiers selected during machine learning model development serve as identifiers that, when combined and analyzed, can be compared to what is expected, based upon DUT and DUT package markings, by the user to determine an integrity of a device including whether a DUT is repackaged, remanufactured, counterfeit, inferior, suspect, modified, etc. The programmable device categorization processing system 1302 collects data from a DUT using telemetry bitstreams as described above, queries the classification models using the collected data, and based on the classification model results, informs the user whether the device is authentic.

In example embodiments, the device categorization system 1302 may be a standalone tool that an end user can employ to collect data and immediately query the models for a device of interest. A programming cable, e.g., a JTAG cable, may be used to connect the device categorization system to the DUT to receive telemetry sensor measurement data. Alternatively, the device categorization system 1302 can read the telemetry sensor data via a serial interface between the DUT and the device categorization system. For “loose part” DUT evaluation, a test platform may be used. The programmable device categorization system can be deployed at any point throughout the device supply chain including, for example, at a loose parts stage, a populated board stage, or a fielded system.

In an example embodiment, the programmable device categorization system 1302 determines whether a DUT is a counterfeit, aged, repackaged, inferior, or modified device, or otherwise suspect due to the resulting misclassification that occurs when a device has been marked as something other than what it is. If a device is being sold as new, the features, lot number, date code, or trace code will all contain features of new devices. If the device has aged, then it will have degraded and the data from the telemetry bitstreams will result in a different classification category than the expected category determined by the data identifier. The programmable device categorization system obtains the data from a DUT, compares the data to the training data of known and authentic devices, and determines whether the DUT is suspect.

Given trained models for a device, the programmable device categorization system 1302 can be used to categorize individual devices. An example process will be illustrated using a specific example device. An Intel Cyclone III FPGA device can be connected via JTAG to a computer, such as that shown in FIG. 28, that implements the programmable device categorization system 1302 shown in FIG. 13. The Intel Cyclone III FPGA is connected via JTAG and the same telemetry sensors are loaded onto the Device Under Test (DUT). Data is collected in the same manner as it was during characterization (as described for the programmable device characterization system 1301) and read back through JTAG to the computer. The programmable device categorization system 1302 loads the telemetry sensor data and accepts expected data identifier input from the user via the user interface, in this example expected Intel Cyclone III FPGA device input. The telemetry sensor data is used as input for a query to the Intel Cyclone III FPGA device model(s). The Intel Cyclone III FPGA device model(s) compare the DUT sensor data to the expected Intel Cyclone III FPGA device training data. If the DUT reasonably matches, e.g., within a predetermined threshold amount, the user interface can confirm that the DUT is an Intel Cyclone III FPGA device. The DUT may also be matched against other device categories that have been modeled.

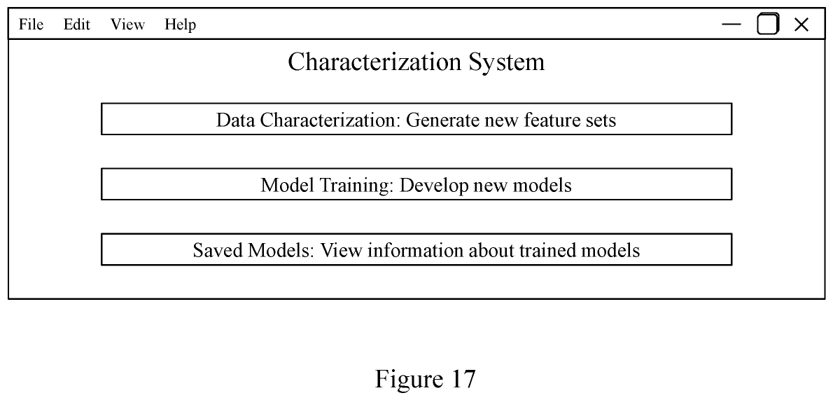

FIG. 17 shows an example embodiment of a characterization system user interface (UI) main menu for the programmable device characterization system 1301 with a data characterization menu option to generate new feature datasets, a model training option to develop one or more new models for classifying a device under test, and a saved models tab as example menu selection option to view information about trained ML models for classifying a device under test. A user selects the appropriate one of these options with a cursor, finger, voice-recognition prompt, etc.

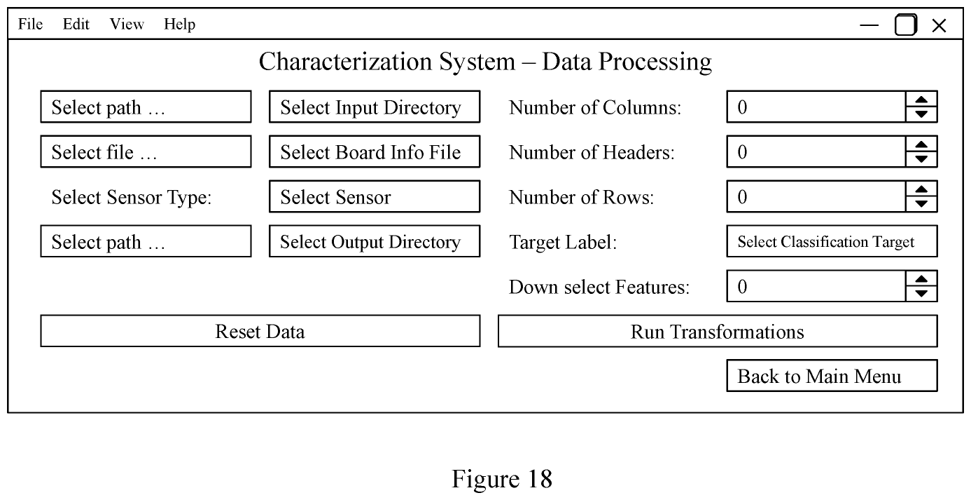

FIG. 18 shows an example embodiment of a programmable device characterization system data analysis menu. A user may select an “Input Directory” to specify the directory containing input data for characterization. A “Board Info File” menu option specifies the file containing data labels. A “Sensor” menu option specifies the sensor type of the input data for characterization. An “Output Directory” menu option specifies the directory to which transformations should be output. “Number of Columns”, “Number of Headers”, and “Number of Rows” menu options specify the dimensions of metadata contained in the input data for characterization and are used to exclude the metadata from characterization. A “Target Label” menu option specifies the label to be targeted for categorization. A “Down select Features” menu option specifies the feature reduction for transformation processes.

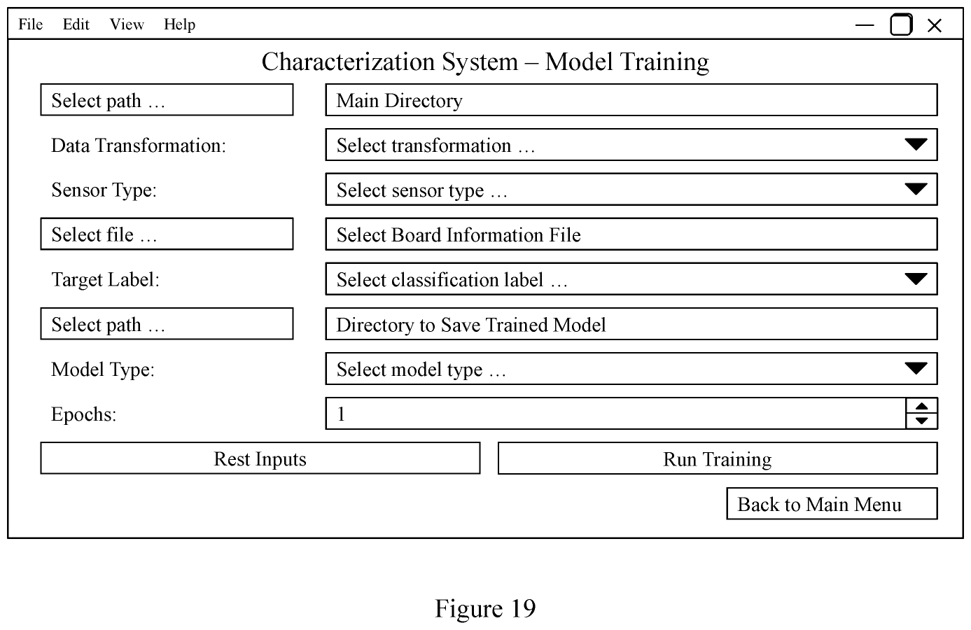

FIG. 19 shows an example embodiment of a model training main menu including a sub-menu to select one of various data transformations for model training (e.g., see the example transformations in Table 1), select a telemetry sensor type such as the example sensor types described above, select a board information file which contains feature labels, target label for the data, ML model to output, and epochs for specifying the number of training iterations to perform using all of the training data.

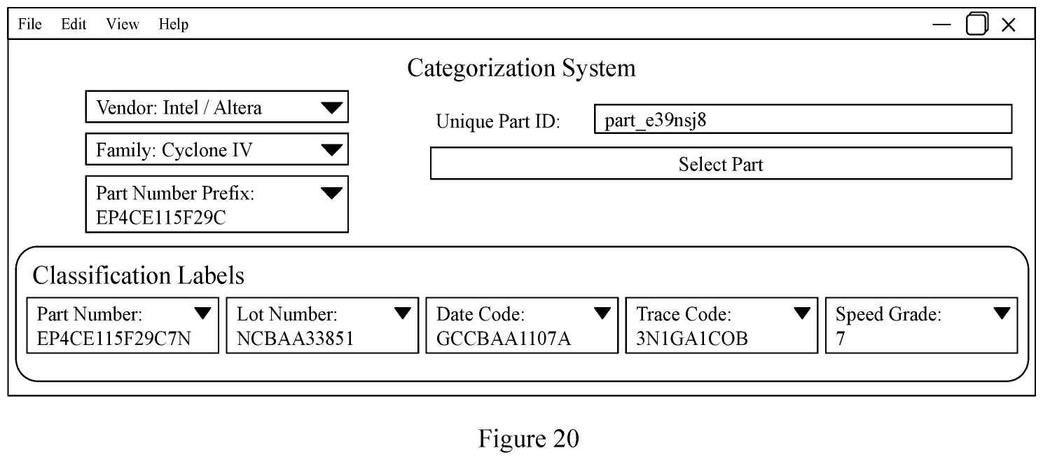

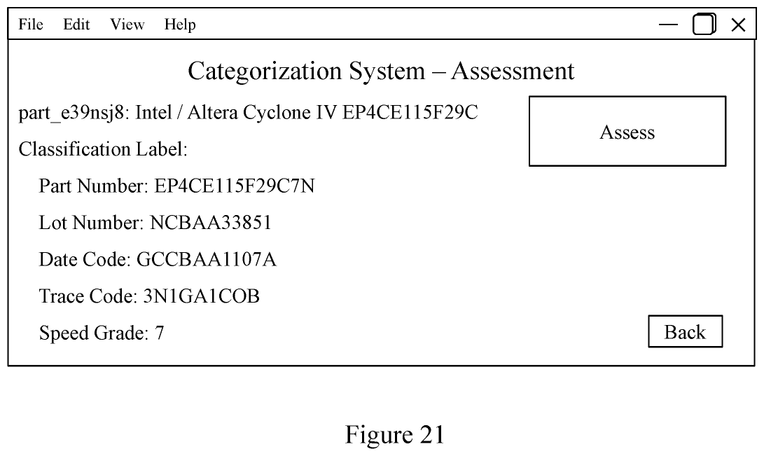

An example embodiment of a user interface display menu of the programmable device categorization system is shown in FIG. 20 where the user is prompted to select the vendor of the part to be assessed. Once a vendor is selected, the user selects a subset of families of devices, a part number, and a part identifier (ID). These are examples of device identification captured in the data collection process. The underlying models classify the part number, lot number, date code, trace code, or speed grade. Input of all available classification identifiers by the user into the system may produce a more comprehensive assessment. When the user selects the “Select Part” button on the user interface, the user is taken to an assessment dialog display screen, described below in conjunction with FIG. 21. If there is an issue with the inputs, an error message is provided with more details about why the input is invalid, and the user can correct the issue before assessing the device under test.

FIG. 21 shows an example embodiment of a user interface display menu where the provided details regarding the classification are provided, and the verification process can be initiated. When the user selects an “Assess” button in the assessment dialog screen, the computer system will check that a part is connected, e.g., to a JTAG chain, and then determine which telemetry bitstreams are available for the part number. Given the list of available bitstreams for data collection, the computer system loads each bitstream and collects sensor data from the connected part or device. Once data is collected, the computer system assesses potential combinations of sensor data to determine which models are available for classifying the part or device. A list of available models for available sensor data is processed to determine the model with the likely highest validation accuracy for each desired classification label. The sensor data is then transformed to conform to the input format needed for each model, and formatted sensor data is processed using the model to categorize the data. The validity of a part or device is determined, for example, by trying to match the classification result with the expected result for each classification label.

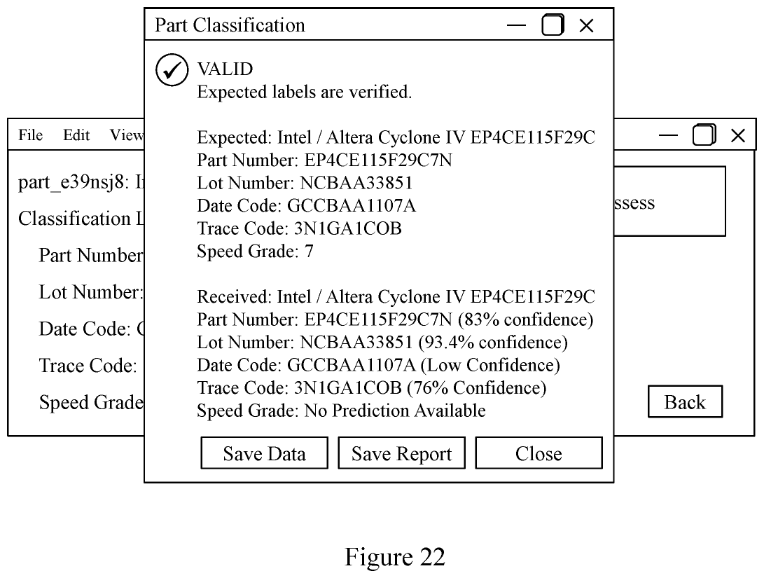

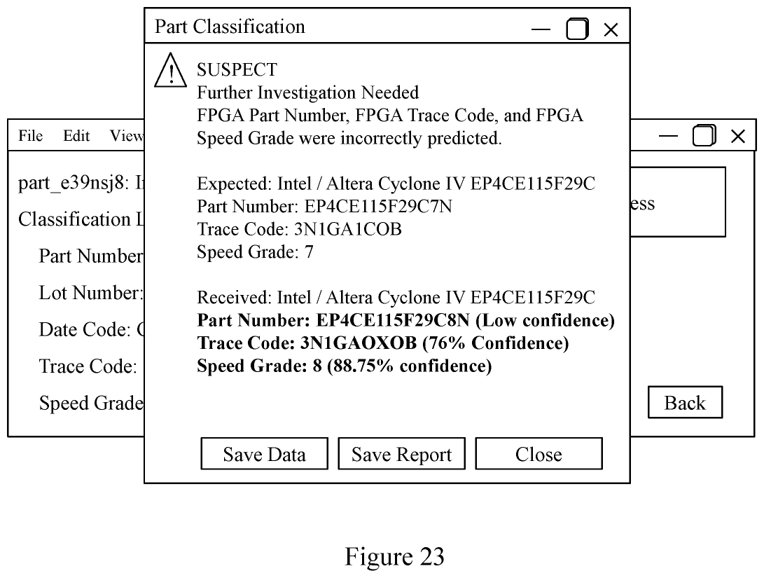

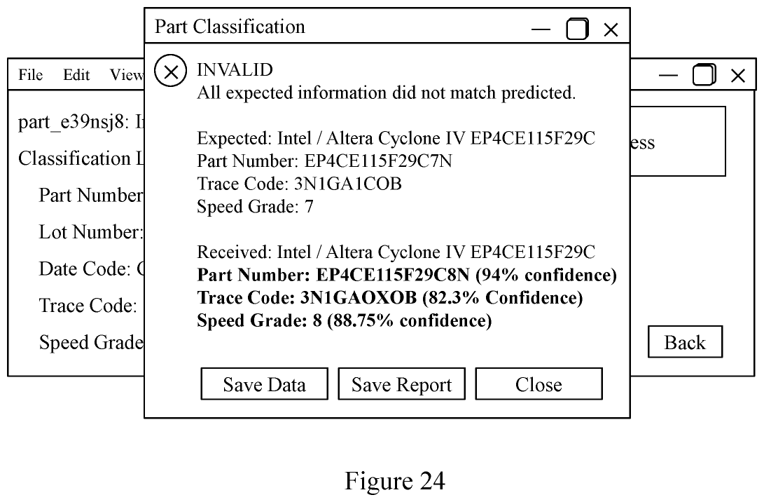

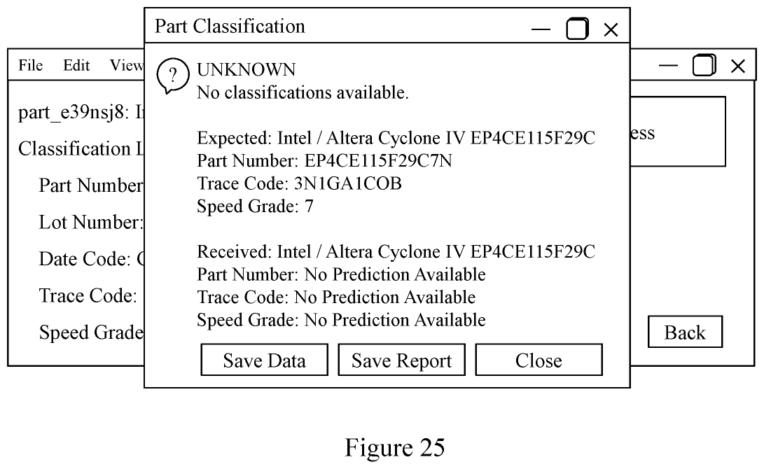

FIGS. 22-25 show example displays of potential part classification results including a valid part classification dialog example in FIG. 22; a suspect part classification dialog example in FIG. 23; an invalid part classification dialog example in FIG. 24; and an unknown part classification dialog example in FIG. 25.

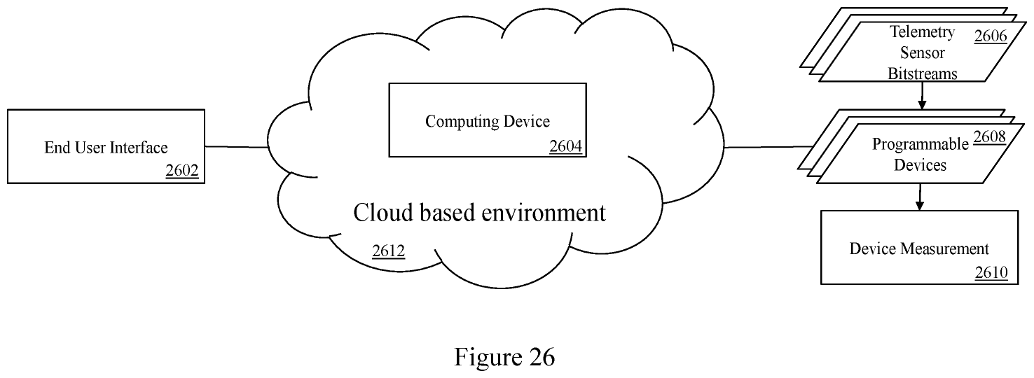

FIG. 26 illustrates an example embodiment for categorization of programmable devices 2608 using a computing device 2604 in a cloud-based environment 2612. A computing device 2604, in a cloud-based environment 2612, interfaces with local programmable devices 2608 that may be categorized. Device measurement 2610 is performed locally on the programmable devices and resulting sensor data is output to the computing device 2604, in a cloud-based environment 2610, which contains the programmable device characterization processing system or programmable device categorization system. An example of use of this embodiment is to assess FPGA devices in a fielded system with access to a cloud-based computing environment.

FIG. 27 illustrates an example embodiment for categorization of

programmable devices 2708 in a cloud-based environment 2712. A computing device 2704 interfaces with a cloud-based environment 2712 to access programmable devices 2708 that may be categorized. Device measurement 2710 is performed in the cloud-based environment 2712 on the programmable devices 2708 and resulting sensor data is output to a computing device 2704 which contains the programmable device characterization processing system 1301 or the programmable device categorization system 1302. An example of use of this embodiment is to assess FPGA devices that are present in cloud data centers.

FIG. 28 illustrates an example computer device 2800 that may be used according to some embodiments to implement the process steps, function blocks and the operations of the telemetry sensor generation and programming in a programmable device, the programmable device sensor measurements, the programmable device characterization system, the programmable device categorization system, and the user interface and menus. In some embodiments, a computing device 2800 includes one or more of the following: one or more processors 2802; one or more memory devices 2804; one or more network interface devices 2806; one or more display interfaces 2808; and one or more user input adapters 2810. Additionally, in some embodiments, the computing device 2800 is connected to or includes a display device 2812. As will be explained below, these elements (e.g., the processors, memory devices, network interface devices, display interfaces, user input adapters, display device) are hardware devices (for example, electronic circuits or combinations of circuits) that are configured to perform various functions for the computing device.

In some embodiments, each or any of the processors 2802 is or includes, for example, a single-core or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 2802 uses an instruction set architecture such as x86 or Advanced RISC Machine (ARM).

In some embodiments, each or any of the memory devices 2804 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 2802). Memory devices 2804 are examples of non-volatile computer-readable storage media.

In some embodiments, each or any of the network interface devices 2806 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all the circuitry in the housing to perform transmission and reception. In some embodiments, the transmitter and receiver of a transceiver may not share any common circuitry and/or may be in the same or separate housings.

In some embodiments, each or any of the display interfaces 2808 is or includes one or more circuits that receive data from the processors 2802, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 2812, which displays the image data. Alternatively, or additionally, in some embodiments, each or any of the display interfaces 2808 is or includes, for example, a video card, video adapter, or graphics processing unit (GPU).

In some embodiments, each or any of the user input adapters 2810 is or includes one or more circuits that receive and process user input data from one or more user input devices (not shown) that are included in, attached to, or otherwise in communication with the computing device 2800, and that output data based on the received input data to the processors 2802. Alternatively, or additionally, in some embodiments each or any of the user input adapters 2810 is or includes, for example, a PS/2 interface, a USB interface, a touchscreen controller, or the like; and/or the user input adapters 2810 facilitates input from user input devices (not shown) such as, for example, a keyboard, mouse, trackpad, touchscreen, etc.

In some embodiments, the display device 2812 may be a Liquid Crystal Display (LCD) display, Light Emitting Diode (LED) display, or other type of display device. In embodiments where the display device 2812 is a component of the computing device 2800 (e.g., the computing device and the display device are included in a unified housing), the display device 2812 may be a touchscreen display or non-touchscreen display. In embodiments where the display device 2812 is connected to the computing device 2800 (e.g., is external to the computing device 2800 and communicates with the computing device 2800 via a wire and/or via wireless communication technology), the display device 2812 is, for example, an external monitor, projector, television, display screen, etc.

In various embodiments, the computing device 2800 includes one, or two, or three, four, or more of each or any of the above-mentioned elements (e.g., the processors 2802, memory devices 2804, network interface devices 2806, display interfaces 2808, and user input adapters 2810). Alternatively, or additionally, in some embodiments, the computing device 2800 includes one or more of: a processing system that includes the processors 2802; a memory or storage system that includes the memory devices 2804; and a network interface system that includes the network interface devices 2806.

The computing device 2800 may be arranged, in various embodiments, in many different ways. In various embodiments, the computing device 2800 includes one, or two, or three, four, or more of each or any of the above-mentioned elements (e.g., the processors 2802, memory devices 2804, network interface devices 2806, display interfaces 2808, and user input adapters 2810). Alternatively, or additionally, in some embodiments, the computing device 2800 includes one or more of: a processing system that includes the processors 2802; a memory or storage system that includes the memory devices 2804; and a network interface system that includes the network interface devices 2806. Alternatively, or additionally, in some embodiments, the computing device 2800 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 2802 and the network interface devices 2806; or the single SoC (or the multiple SoCs) may include the processors 2802, the network interface devices 2806, and the memory devices 2804; and so on. Further, the computing device 2800 may be arranged in some embodiments such that: the processors 2802 include a multi-(or single)-core processor; the network interface devices 2806 include a first short-range network interface device (which implements, for example, WiFi, Bluetooth, NFC, etc.) and a second long-range network interface device that implements one or more cellular communication technologies (e.g., 3G, 4G LTE, CDMA, etc.); and the memory devices 2804 include a RAM and a flash memory. As another example, the computing device 2800 may be arranged in some embodiments such that: the processors 2802 include two, three, four, five, or more multi-core processors; the network interface devices 2806 include a first network interface device that implements Ethernet and a second network interface device that implements WiFi and/or Bluetooth; and the memory devices 2804 include a RAM and a flash memory or hard disk.

As previously noted, whenever it is described in this document that a module or process performs any action, the action is performed by underlying hardware elements according to the instructions that comprise the module. As stated above, the various modules of the Programmable Device Categorization Processing System 1301 and Programmable Device Categorization System 1302 computer system(s) module will be referred to individually for clarity as a “component” for the remainder of this paragraph, are implemented using an example of the computing device 2800 of FIG. 28. In such embodiments, the following applies for each component: (a) the elements of the computing device 2800 shown in FIG. 28 (i.e., the one or more processors 2802, one or more memory devices 2804, one or more network interface devices 2806, one or more display interfaces 2808, and one or more user input adapters 2810), or appropriate combinations or subsets of the foregoing) are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the memory devices 2804 (e.g., in various embodiments, in a volatile memory device such as a RAM or an instruction register and/or in a non-volatile memory device such as a flash memory or hard disk) and all actions described herein as performed by the software modules are performed by the processors 2802 in conjunction with, as appropriate, the other elements in and/or connected to the computing device 2800 (i.e., the network interface devices 2806, display interfaces 2808, user input adapters 2810, and/or display device 2812); (c) alternatively or additionally, to the extent it is described herein that the component processes and/or otherwise handles data, in some embodiments, such data is stored in the memory devices 2804 (e.g., in some embodiments, in a volatile memory device such as a RAM and/or in a non-volatile memory device such as a flash memory or hard disk) and/or is processed/handled by the processors 2802 in conjunction with, as appropriate, the other elements in and/or connected to the computing device 2800 (i.e., the network interface devices 2806, display interfaces 2808, user input adapters 2810, and/or display device 2812); (d) alternatively or additionally, in some embodiments, the memory devices 2804 store instructions that, when executed by the processors 2802, cause the processors 2802 to perform, in conjunction with, as appropriate, the other elements in and/or connected to the computing device 2800 (i.e., the memory devices 2804, network interface devices 2806, display interfaces 2808, user input adapters 2810, and/or display device 2812), each or any combination of actions described herein as performed by the component and/or by any software modules described herein as included within the component.

The hardware configurations shown in FIG. 28 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 28, (e) via other hardware arrangements, architectures, and configurations, and/or via combinations of the technology described in (a) through (e).

There are many technical advantages of the subject matter described above. One example advantage includes non-destructive device characterization with no specialized external testing equipment needed. This allows counterfeit etc. assessment of programmable devices throughout the programmable device lifecycle including at the beginning of life such as part supply, manufacturing, and board assembly, during life such as deployment of a programmable device, and at end of life for ensuring the intended programmable device is being decommissioned. Additionally, assessment can be performed on loose programmable devices, programmable devices on populated boards, as well as programmable devices already in use in systems deployed in the field. Still further, categorization of a DUT may be done while another application is running on the DUT. The technology described above requires only minimal external equipment, i.e., a cable connecting it to a computer and a test board if the DUT is a loose part.

One example application of the technology described above is for categorization of CPU devices. CPU devices can be standalone or contained as a processor core in SoC and MPSoC devices. A telemetry sensor architected like the previously described memory block sensor can adjust operating frequency of the CPU while recording errors during computation. Such telemetry data may be used to categorize the CPU based on the operating frequency at which errors begin to occur. Additionally, a telemetry sensor may be used to benchmark performance characteristics of CPU devices including how many computations occur in a period. Based on the benchmark characterization information gathered from a CPU device, the CPU device(s) may be categorized for example as repackaged, remanufactured, counterfeit, inferior, suspect and/or modified or not.

In other example embodiments, the technology described above may be used to test GPU and Al hardware.

In addition to determining repackaged, remanufactured, counterfeit, inferior, suspect and/or modified programmable devices, another example embodiment of the device categorization technology is sorting of loose parts. As an example of this embodiment, automated sorting equipment assigned to “bin” a collection of similar programmable chips with various speed grades by speed grade uses the approach described above to embed sensors in each programmable chip, read back the data detected by the embedded sensors, and determine the device category for each programmable chip, then place each programmable chip into an appropriate bin.

Another example embodiment of the technology identifies parts for remanufacturing boards and identification of unknown parts. As an example of this embodiment, an existing system may contain a board with a part for which package markings are no longer readable that is generally known to be a certain type of FPGA; however, exact details, such as speed grade and manufacturing date, etc., are unknown. If the speed grade needs to be matched for performance reasons and the manufacturing date (or lot number) needs to be determined due to shifts in manufacturing processes over time, the approach described above is used to embed sensors in each part, read sensor results, and identify the speed grade and manufacture date for the part based upon pre-trained machine learning models.

The technology described here can be applied, for example, to efficient determination of an integrity of a device including determining repackaged, remanufactured, counterfeit, inferior, suspect and/or modified programmable devices which can be employed for supply chain assurance. The sensor technology also has additional example applications in environmental sensing, precision timing measurements, functional measurements, power and thermal analysis, and effectors. The sensor technology may also be applied to any system in which physical properties can be measured. The modeling techniques described above may also be applied to any dataset collected from sensors designed to characterize a device or system of interest. Examples include environmental sensing in which physical changes in the environment can be measured, power and thermal analysis in which power characteristics and timing features can also be measured within a device, and others.

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a flash memory, a magnetic medium such as a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

Although process steps, algorithms or the like, including without limitation with reference to FIGS. 1-28, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A programmable device comprising:
a programming interface configured to receive sensor construction information;
one or more resources configured to be programmed with the sensor construction information to implement sensors on the programmable device;
data processing circuitry configured to execute the sensor construction information to cause the sensors to measure and generate sensor information including characteristics of the programmable device; and
input/output (I/O) circuitry configured to output the sensor information to a programmable device categorization system.

2. The programmable device in claim 1, further comprising a memory configured to store the sensor information.

3. The programmable device in claim 1, wherein the sensor construction information includes one or more telemetry bitstreams.

4. The programmable device in claim 1, wherein the sensors are configured to obtain data about the one or more resources operated in the programmable device to measure and generate sensor information including characteristics of the programmable device.

5. The programmable device in claim 1, wherein the sensors include one or more of the following: a ring oscillator sensor, a memory block sensor, a phase locked loop sensor, a multiplier sensor, and a path delay measurement sensor.

6. The programmable device in claim 1, wherein the resources include one or more of CPU resources, timing resources, logic resources, memory resources, and signal processing resources.

7. The programmable device in claim 1, wherein the programmable device is one of the following: an FPGA, a CPU, an ASIC, a GPU, or an AI processor.

8. A programmable device characterization processing system for generating categorization models for categorizing programmable devices, the programmable device characterization processing system comprising:
at least one computer including at least one hardware processor; and
storage to store instructions that when executed by the at least one hardware processor, cause the programmable device characterization processing system to:
load one or more sensor programs into programmable resources of a known programmable device;
operate the sensor programs in the known programmable device to generate one or more known device characterization datasets including characteristics about the known programmable device;
determine for the known programmable device one or more device category identifiers;
assign one or more device categories to the one or more known device characterization datasets based on the one or more device category identifiers;
process the one or more known device characterization datasets by one or more modeling processes to develop one or more categorized device models for the known programmable device; and
provide at least one of the one or more of the categorized device models to categorize a programmable device under test.

9. The programmable device characterization processing system in claim 8, wherein the one or more modeling processes includes:
modifying modeling parameters for each model process based a performance of the model to predict characteristics about the known programmable device, and determining convergence of the model when the performance reaches a predetermined threshold.

10. The programmable device characterization processing system in claim 8, wherein instructions, when executed by the at least one hardware processor, cause the programmable device characterization processing system to develop multiple categorized device models, each providing a corresponding categorization of a set of known programmable device.

11. The programmable device characterization processing system in claim 10, wherein the instructions, when executed by the at least one hardware processor, cause the programmable device characterization processing system to process the multiple categorized models for the programmable device under test and either select an optimal one of the multiple categorized device models or combine some of the multiple categorized device models to produce a resulting categorized device model to categorize the set of known programmable devices.

12. The programmable device characterization processing system in claim 8, wherein the instructions, when executed by the at least one hardware processor, cause the programmable device characterization processing system to develop one or more categorized device models for each sensor program and/or each device category.

13. The programmable device characterization processing system in claim 8, wherein the one or more categorized device models include one or more of machine learning models, one or more statistical models, and one or more mathematical models.

14. The programmable device characterization processing system in claim 8, wherein the instructions, when executed by the at least one hardware processor, cause the programmable device characterization processing system to detect and remove erroneous data from the one or more known device characterization datasets and to perform data transformations on the one or more known device characterization datasets.

15. A programmable device categorization system for categorizing a programmable device under test (DUT) that includes programmable resources, the programmable device categorization system comprising:
at least one computer including at least one hardware processor; and
storage to store instructions that when executed by the at least one hardware processor, cause the programmable device categorization system to:
load a sensor program into the programmable resources of the DUT, operate the sensor program in the DUT to generate sensor information including characteristics about the DUT;
receive and store in the storage the sensor information from the DUT;
process the sensor information from the DUT using a categorization model to generate categorization information for the DUT; and
output the categorization information.

16. The programmable device categorization system in claim 15, wherein the output categorization information includes information indicating one or more of the following: an integrity of the DUT, whether the DUT is a repackaged, remanufactured, counterfeit, inferior, suspect, or modified device, and an age of the DUT.

17. The programmable device categorization system in claim 15, wherein the output categorization information is useable to identify the DUT, to sort multiple DUTs, or both.

18. The programmable device categorization system in claim 15, wherein the instructions that when executed by the at least one hardware processor, cause the programmable device categorization system to:
load multiple sensor programs into the programmable resources of the DUT;
operate each of the multiple sensor programs in the DUT to generate corresponding sensor information including characteristics of about the DUT;
receive and store in the storage the corresponding sensor information from each of the multiple sensor programs; and
for each of the multiple sensor programs, process the corresponding sensor information using a categorization model to generate and output categorization information for the DUT.

19. The programmable device categorization system in claim 15, wherein the instructions that when executed by the at least one hardware processor, cause the programmable device categorization system to process the sensor information from the DUT using multiple categorization models to generate categorization information for the DUT.

20. The programmable device categorization system in claim 15, wherein the instructions that when executed by the at least one hardware processor, cause the programmable device categorization system to receive operator input regarding expectations for the DUT and process the operator input along with the sensor information from the DUT using one or more categorization models to generate categorization information for the DUT.

21. The programmable device categorization system in claim 15, wherein the programmable device categorization system is configured to categorize the DUT at any point in a supply chain of the DUT.

22. The programmable device categorization system in claim 15, wherein the programmable device categorization system is configured to categorize the DUT while another application is running on the DUT.

23. A system comprising:
a programmable device characterization processing system to generate categorization models for categorizing programmable devices, the programmable device characterization processing system comprising:
at least one computer including at least one hardware processor; and
storage to store instructions that when executed by the at least one hardware processor, cause the programmable device characterization processing system to:
load one or more sensor programs into programmable resources of a known programmable device;
operate the sensor programs in the known programmable device to generate one or more known device characterization datasets including characteristics about the known programmable device;
determine for the known programmable device one or more device category identifiers;
assign one or more device categories to the one or more known device characterization datasets based on the one or more device category identifiers;
process the one or more known device characterization datasets by one or more modeling processes to develop one or more categorized device models for the known programmable device; and
provide at least one of the one or more of the categorized device models to categorize a programmable device under test, and a programmable device categorization system to categorize a programmable device under test (DUT) that includes programmable resources, the programmable device categorization system comprising:
at least one computer including at least one hardware processor; and
storage to store instructions that when executed by the at least one hardware processor, cause the programmable device categorization system to:
load a sensor program into the programmable resources of the DUT, operate the sensor program in the DUT to generate sensor information including characteristics about the DUT;
receive and store in the storage the sensor information from the DUT;
process the sensor information from the DUT using a categorization model to generate categorization information for the DUT; and
output the categorization information.

24. A non-transitory storage medium storing instructions, which when executed by one or more data processors, causes the one or more data processors to perform the following steps:
receiving sensor construction information at a programming interface of a programmable device;
configuring one or more resources of the programmable device with the sensor construction information to implement sensors on the programmable device;
executing the sensor construction information causing the sensors implemented on the programmable device to measure and generate sensor information including characteristics of the programmable device; and
outputting the sensor information to a programmable device categorization system.

25. The non-transitory storage medium in claim 24, wherein the sensor construction information includes one or more telemetry bitstreams.

26. A non-transitory storage medium storing instructions, which when executed by one or more data processors, causes the one or more data processors to perform the following:
load one or more sensor programs into programmable resources of a known programmable device;
operate the sensor programs in the known programmable device to generate one or more known device characterization datasets including characteristics about the known programmable device;
determine for the known programmable device one or more device category identifiers;
assign one or more device categories to the one or more known device characterization datasets based on the one or more device category identifiers;
process the one or more known device characterization datasets by one or more modeling processes to develop one or more categorized device models for the known programmable device; and
provide at least one of the one or more of the categorized device models to categorize a programmable device under test.

27. A non-transitory storage medium storing instructions, which when executed by one or more data processors, causes the one or more data processors to perform the following:
load a sensor program into programmable resources of a programmable device under test (DUT);
operate the sensor program in the DUT to generate sensor information including characteristics about the DUT;
receive and store in the storage the sensor information from the DUT;
process the sensor information from the DUT using a categorization model to generate categorization information for the DUT; and
output the categorization information.

28. The non-transitory storage medium in claim 27, wherein the output categorization information includes information indicating one or more of the following: an integrity of the DUT, whether the DUT is a repackaged, remanufactured, counterfeit, inferior, suspect, or modified device, and an age of the DUT.

29. The non-transitory storage medium in claim 27, wherein the output categorization information is useable to identify the DUT, to sort multiple DUTs, or both.

30. A method comprising:
receiving, at a programming interface of a programmable device, sensor construction information;
configuring one or more resources of the programmable device with the sensor construction information to implement sensors on the programmable device;
executing, using data processing circuitry, the sensor construction information that causes the sensors to measure and generate sensor information including characteristics of the programmable device; and
output, via an input/output (I/O) circuitry of the programmable device. the sensor information to a programmable device categorization system.

31. The programmable device in claim 30, wherein the sensor construction information includes one or more telemetry bitstreams.

32. A programmable device characterization processing method for generating categorization models for categorizing programmable devices, the method comprising:
loading one or more sensor programs into programmable resources of a known programmable device;
operating the sensor programs in the known programmable device to generate one or more known device characterization datasets including characteristics about the known programmable device;
determining for the known programmable device one or more device category identifiers;
assigning one or more device categories to the one or more known device characterization datasets based on the one or more device category identifiers;
processing the one or more known device characterization datasets by one or more modeling processes to develop one or more categorized device models for the known programmable device; and
providing at least one of the one or more of the categorized device models to categorize a programmable device under test.

33. A programmable device categorization method categorizing a programmable device under test (DUT) that includes programmable resources, the method comprising:
loading a sensor program into programmable resources of a programmable device under test (DUT);
operating the sensor program in the DUT to generate sensor information including characteristics about the DUT;
receiving and storing in the storage the sensor information from the DUT;
processing the sensor information from the DUT using a categorization model to generate categorization information for the DUT; and
generating an output of the categorization information.

34. The method in claim 33, wherein the output categorization information includes information indicating one or more of the following: an integrity of the DUT, whether the DUT is a repackaged, remanufactured, counterfeit, inferior, suspect, or modified device, and an age of the DUT.

35. The method in claim 33, further comprising:
using the output categorization information to identify the DUT, to sort multiple DUTs, or both.
